(19) United States
(12) Patent Application Publication
(10) Pub. No.: US 2011/0273268 A1
(43) Pub. Date: Nov. 10, 2011

(54) SPARSE CODING SYSTEMS FOR HIGHLY SECURE OPERATIONS OF GARAGE DOORS, ALARMS AND REMOTE KEYLESS ENTRY

(76) Inventor: Fred Bassali, Great Neck, NY (US)

(21) Appl. No.: 13/100,594

(22) Filed: May 4, 2011

Related U.S. Application Data
(60) Provisional application No. 61/333,148, filed on May 10, 2010.

(51) Int. Cl. G08B 29/00

(52) U.S. Cl. 340/5.64

(57) ABSTRACT

A system for remote entry includes at least one trainable radio frequency transmitter having a plurality of selectable codes, any of which selected in accordance with a corresponding training code data. At least one receiver is configured to receive signals from said radio frequency transmitter, where the radio frequency transmitter is configured to transmit, and the receiver is configured to receive, coded radio frequency transmissions containing at least sparse binary codes that include binary transmissions implemented with a small duty cycle, corresponding to the training code data.

### RELATED APPLICATION

This application claims priority to U.S. Provisional Patent Application No. 61/333,148, filed on May 10, 2010, the entirety of which is incorporated by reference.

### BACKGROUND

1. Field of the Invention

This application relates to remote devices. More particularly, this application relates to coding systems used for remote devices.

2. Description of Related Art

Garage Door Opener (GDO) and Remote Keyless Entry (RKE) systems and car alarms utilizing RF (radio frequency) signal have been available for several decades. There are two types of coding schemes used for the operations of such devices, fixed codes and rolling codes.

The earlier models of these devices use fixed codes which provide a relatively low security against hacking by potential intruders. In a typical system, both the transmitter and the receiver utilize a dip switch with typically 8 to 14 positions. A limited number of frequencies are provided by different brands which are available in the market. Both types of systems, i.e., fixed and rolling codes are vulnerable to security issues.

The second generation of GDO's or RKE systems utilize rolling code scheme wherein for every activation a new code having a mathematical relationship with the previous codes is transmitted. Devices operating with rolling codes provide comparatively a better protection against unauthorized intrusions than the devices utilizing fixed codes. An individual who has a temporary access to the GDO or RKE remotes, e.g., a parking attendant cannot utilize the copied code from a rolling code device to activate a garage door or unlock a car door.

### Vulnerabilities & Disadvantages of Fixed Code Systems—

(1) A potential intruder can utilize an RF signal generator in conjunction with a binary counter circuit and an antenna in order to illegally break into a garage or a vehicle. At a time, the signal generator is tuned to one of the known frequencies and the binary counter circuit produces all the possible binary combinations modulating the RF signal generator feeding the antenna. Using such an arrangement for a typical fixed code system 14 bits in a period of about one minute any garage door is opened or an automobile lock is deactivated. In a 14 bit fixed code scheme, there is a combination of 2¹⁴=4096 possible codes. For instance, when a burst length of 1 mS (millisecond) to activate a GDO or RKE is used, in order to produce the 4096 different combinations of codes with a binary counter circuit only a period of 1 mS×4096=4.09 S is required for each frequency. When such a method is used, in order to go through the 10 different common frequencies, it takes only a total time of about 41 seconds for opening a garage door or an automobile door.

(2) A potential intruder who has a temporary access to a GDO/RKE, e.g., a parking attendant, can look at the dip switch combination and copies the code of the GDO/RKE.

(3) A potential intruder who has a temporary access to a GAG/RKE, e.g., a parking attendant, can utilize a Universal (Trainable) Garage Door Opener to copy the code and frequency of the GDO/RKE.

(4) In parking lots of apartment building complexes or office buildings, often the tenants/parking subscribers are changed. After tenants leave the complex or their subscriptions to the parking lots are expired, they could still use their fixed code transmitters and illegitimately access the premises.

### Vulnerability of Rolling Code Systems—

(1) Similar to the fixed code case, as discussed above, in a rolling code system, an intruder with an RF signal generator and a binary counter circuit would still be able to produce the appropriate code and frequency for an illegal entry into a garage or unlocking a car door.

(2) Similar to the fixed code case, in parking lots of apartment building complexes or office buildings, often the tenants/parking subscribers are changed. After tenants leave the complex or their subscriptions to the parking lots are expired, they could still use their rolling code transmitters and illegitimately access the premises.

Difficulties Encountered from Use of Rolling Code Systems—

(1) The GDO manufacturers typically supply two or three GDO rolling code transmitters with each garage door opener system purchase. However, often after some time, the users would need to purchase more GDO transmitters (e.g., as a result of damage, loss or purchase of new vehicles). New transmitters are either ordered from the original manufacturer or an aftermarket manufacturer or alternatively universal transmitters capable of handling rolling codes are available in many models of automobiles. In any of these solutions, i.e., new transmitters from the manufacturer or trainable transmitters, the base code of the new transmitter has to be supplied to the receiver during the training procedure which involves considerable difficulties for many users. This is due to the fact that in the rolling code systems, the receiver and not the transmitter needs to be trained which necessitates accessing and pressing the training button located on the receiver unit while the transmitter is activated. The receiver units are commonly mounted adjacent to the garage door opener motors which are installed at 7-10 ft above the ground. Accessing the receiver is required for every new transmitter/universal transmitter purchase and requires climbing a ladder by someone with sufficient technical background. In the remote keyless entry (RKE), receiver systems for such an access are not typically provided. However, if such access were to be provided to the users, a potential intruder who has temporary access to the automobile, such as a parking attendant can train the receiver with his own transmitter for future illegal access.

### Other Inconveniences & Security Issues of Fixed/Rolling Code Systems—

In parking lots of apartment building complexes or office buildings, often the tenants/parking subscribers are changed. However, after tenants leave the complex or their subscription to the parking expires, they could still use their fixed code/rolling code transmitters and illegitimately access the premises.

### OBJECTS AND SUMMARY

The present arrangement overcomes the drawbacks associated with the prior art and provides for a new coding scheme, sparse code (“SparsCode”) for garage door openers (GDO) and remote keyless entry systems (RKE) that provides a better security than the existing fixed/rolling codes for the users. Use of a SparsCode eliminates the need to climb a ladder to train a rolling code receiver. Any transmitter with SparsCode capability can be trained to transmit the activation codes for garage door openers or keyless remote entry systems by key entries. The code information is supplied to the user with the purchase of a receiver unit.

In one preferred embodiment, for situations such as sale of the automobile or leaving of a tenant from a building complex, i.e., when the codes should no longer be valid, the old codes can be permanently deactivated. The present receiver may be utilized as an add-on receiver to existing installed receiver(s) in order to enable the operation of universal transmitters or other transmitters which have SparsCode capability while maintaining the operation of the existing transmitters.

To this end a system is provided for remote entry includes at least one trainable radio frequency transmitter having a plurality of selectable codes, any of which selected in accordance with a corresponding training code data. At least one receiver is configured to receive signals from said radio frequency transmitter, where the radio frequency transmitter is configured to transmit, and the receiver is configured to receive, coded radio frequency transmissions containing at least sparse binary codes that include binary transmissions implemented with a small duty cycle, corresponding to the training code data.

### BRIEF DESCRIPTION OF DRAWINGS

The present invention can be best understood through the following description and accompanying drawings, wherein:

FIG. 1 depicts an RKE fob in accordance with one embodiment;

FIG. 2 depicts a visor equipped with a transmitter which has four keys and an LED, in accordance with one embodiment;

FIG. 3 depicts a block diagram for transmitter components, in accordance with one embodiment;

FIG. 4 depicts a receiver, in accordance with one embodiment; and

FIG. 5 is a flow chart for training procedure of a transmitter of FIG. 3, in accordance with one embodiment.

### DESCRIPTION OF THE PREFERRED EMBODIMENTS

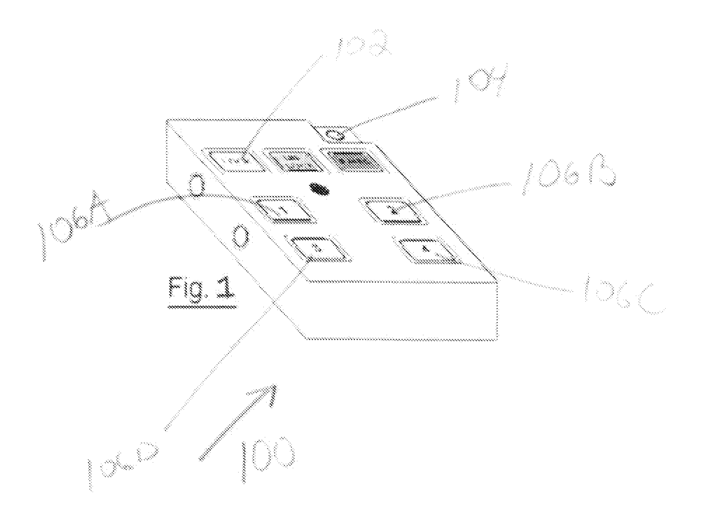

In one embodiment, FIG. 1 depicts an RKE (Remote Keyless Entry) fob 100 which in addition to the common keys 102 and an LED 104 has four other keys 106A-106D for training an internal transmitter (shown below) for SparsCode capability, discussed in more detail below. Similar key structures may be implemented as an addition to existing fob of a car key.

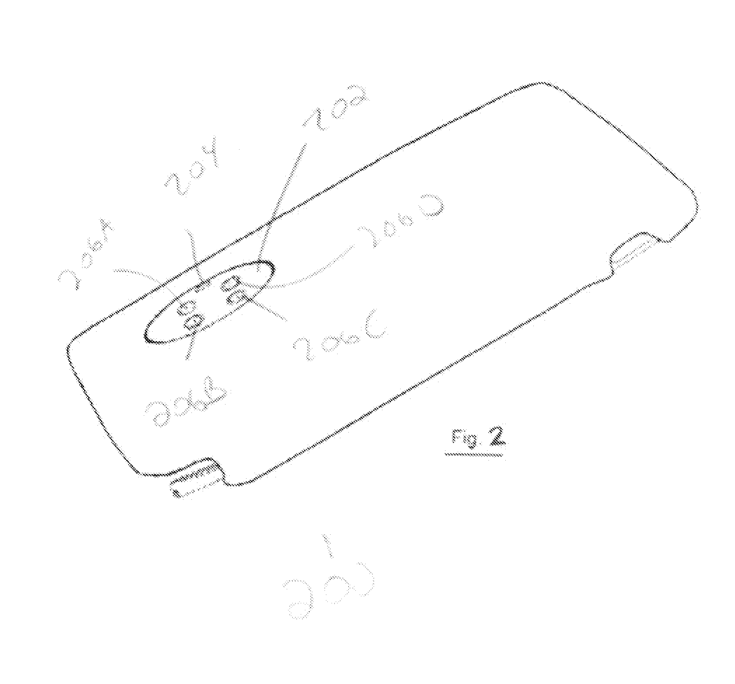

In one embodiment as shown in FIG. 2, a visor 200 is equipped with a transmitter 202 which has four keys 206A-206D and an LED 204 to be used within the context of the SparsCode capability discussed below. Similar key structures may be added to a rear view mirror or overhead console of a car.

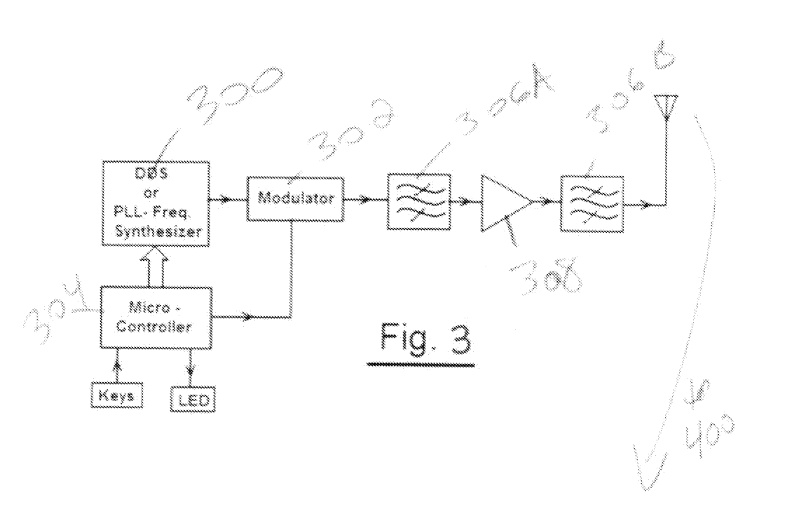

FIG. 3 depicts a block diagram for exemplary transmitter components for either one of transmitter 100 or 202 described above. A signal is generated by an accurate frequency generator such as DDS (Direct Digital Synthesis) or PLL (Phase-Locked Loop) frequency synthesizer 300. The advantage of DDS over a PLL is that it provides sinusoidal signal with amplitude control so the optimum levels with very low harmonic content is generated. However, it is understood that synthesizer 300 may be of either kind as desired.

The output of synthesizer 300 is modulated in a modulator 302 by the data produced by a micro controller 304. Band pass filters 306A and 306B, band pass filter the output of modulator 302 to reduce the harmonics, both before and after signal amplification by amplifier 308.

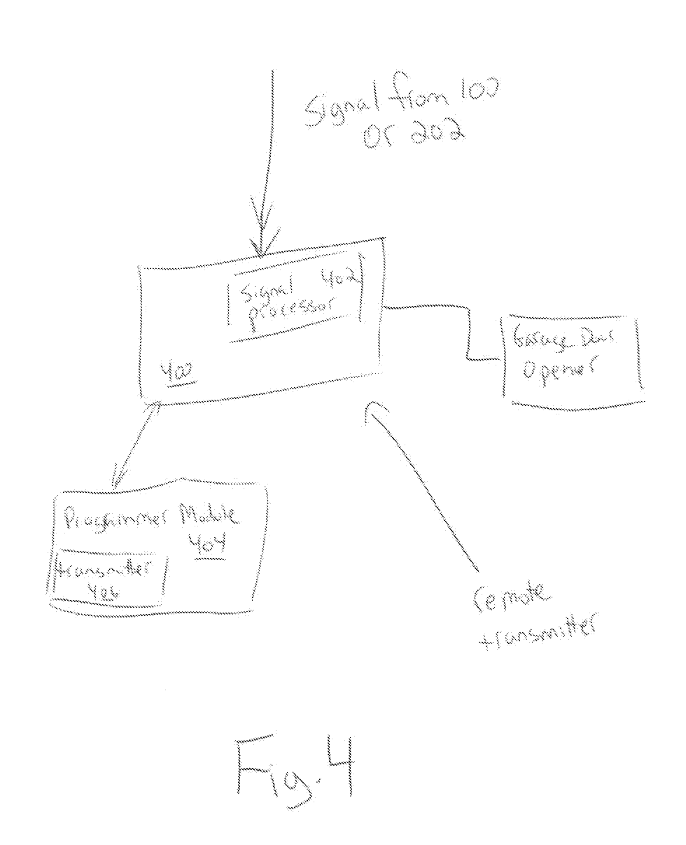

In one embodiment, as shown in FIG. 4, a receiver 400 is composed of a processor 402 to handle a long code sparse according to a typical receiver for handling such signals. In a preferred arrangement a power saving (important for RKE systems) arrangement may be utilized. For example, transmitter 100 transmits a CW signal at a different frequency (f₂) than the operating frequency (f₁) which handles the data. Receiver 400 is tuned at the frequency (f₂) and is turned on for a small fraction of the time. When receiver 400 senses a CW signal at the frequency (f₂), it turns on and tunes to the operating frequency (f₁) for receiving the data signal.

In another embodiment, receiver 400 includes a master code manager module 404 capable of receiving master codes from a remote transmitter. This arrangement allows for external programming for deactivating an old code or activating a new code. Such an arrangement requires a programmer module 406 which is composed of a transmitter which transmits an activation master code followed by a code which needs to be activated and transmits a deactivation master code followed by a code which needs to be deactivated.

The described receiver 400 according to the present arrangement can function as a standalone receiver or in parallel with an existing receiver or a plurality of receivers. In such an arrangement, receivers 400 can function independent of each other since the receivers' 400 outputs are contact closures and are connected in parallel. To avoid climbing on a ladder for installation of the “add-on receiver 400” the output ports of receiver 400 can be wired to the wall garage door opening switch which is electrically the same point as the contact closures. Add-on receiver 400 coding and frequency maps can be provided to the universal garage door opener manufacturers for utilizing them in their universal transmitters. Such an arrangement does not pose any security compromises to the users as the only way to program a universal transmitter is by entering the “training code” which is only known by the user.

Turning now to the coding operations between transmitters 100 and 202 and receiver 400, it is noted that in existing prior art, fixed and rolling codes systems are prone to hacking and subsequent intrusions. Addition of every new transmitter to a rolling code system necessitates climbing a ladder in the GDO's (Garage Door Openers) and is not practical in the RKE systems.

There are no provisions for inactivating a tenant's transmitter after he leaves the premises.

The present arrangement provides a superior system which can provide a higher security with more user-friendly methodology of activating and de-activating new transmitters when necessary.

The present arrangement incorporates:

(1) A new coding technique, “sparse coding system” which provides an astronomical number of combinations of codes;

(2) A Trainable Transmitter (IT) (such as transmitter 100) which is trained by entering a “training code” via its keys for duplicating other GDO/RKE transmitters code and frequency without the need to have a physical access to the receiver;

(3) When necessary, use of an “add-on receiver 400” provides to the users the capability to add receiver 400 in parallel with the existing receivers 400 in order to facilitate addition of new transmitters 100 without the inconvenience of climbing a ladder for every time a new transmitter 100 has to be added.

(4) Capability of remotely activating a new code or deactivating an old code in the receiver without the need to climb a ladder or physically press a button.

According to the present arrangement, for a potential intruder even with the use of an RF signal generator in conjunction with a binary counter circuit and an antenna, it would take tens of thousands of years to break into a garage or automobile. This is mathematically demonstrated below, that the “sparse coding system” of the present arrangement provides an astronomical number of combinations of codes and consequently is virtually unbreakable. Furthermore, the code and the frequency of a GDO or RKE transmitter 100, built and programmed according to the present arrangement, cannot be copied with use of a universal (trainable) garage door opener which utilizes a super-heterodyne scheme which detects the carrier of the reference transmitter with frequency sweeps. This is due to the fact that the present transmitter 100 is built having an extremely low duty cycle, namely they transmit RF energy for a very short period of time in comparison to the sweeping time of the universal (trainable) garage door opener.

For example, in a case when the sweep time of the trainable garage door opener is increased, the “incidental FM” effect would reduce the carrier signal and also result in FM sidebands which make the signal identification more difficult. On the other hand, according the present arrangement, making a legitimate copy of a GDO/RKE transmitter can only be done by the owner or an authorized person who is given the pertinent “training code” (e.g., a 20-digit number composed of digits 1, 2, 3 and 4) data which is related to frequency and code and the training is performed by entering “training code” via the keys on the Universal GDO/RKE transmitters. Hence, in the present arrangement, unless the “training code” is manually entered to a trainable (universal) garage door opener, copying of such a code and the frequency by means of a super-heterodyne trainable garage door which performs frequency sweeps is not possible.

To conduct operations, the present arrangement uses a sparse binary code, i.e., a binary string with a very small duty cycle, which is transmitted providing an astronomical number of possible code combinations. In addition to immunity to detection by potential intruders, the short duty cycle of sparse codes saves battery life which is desirable for RKE systems where the battery sizes are quite small and frequent changes of the battery causes a nuisance for the user.

As an example for the sparse code system according to the present arrangement, if a transmission time of 0.1 S and a bit rate of 400,000 bps is used, for each transmission there is (0.1 S×40,000 b/s) K=4,000 bit slots that have to be used. If a duty cycle of 0.2-0.4% is selected, then for each transmission there would be between L=80 to M=160 bits transmitted. N, the possible number of combinations is given by:

$$N = ( \begin{matrix}K \\ L\end{matrix} ) + … + ( \begin{matrix}K \\ L - i\end{matrix} ) + … + ( \begin{matrix}K \\ M\end{matrix} )$$

Using the sparse code assumption, i.e., N>>L and N>>M and utilizing the Stirling's approximation:

$$n ! \approx \sqrt{2 π n} {( \frac{n}{e} )}^{n}$$

It is derived that:

$$N > \sqrt{\frac{2 K}{π ( M + L )}} ( M - L + 1 ) {( \frac{2 K}{M + L} )}^{\frac{M + L}{2}}$$

For K=4000, L=8 and M=16

N>1.61×10³²

In order to produce all the 1.61×10³² combinations, a time period of:

$$\frac{1.61 \times {10}^{32}}{40 , 000 ( Bits \text{/} s ) \times 3600 ( s \text{/} hrs ) \times 24 ( hrs \text{/} day ) \times ( 365 day \text{/} year )} = 1.28 \times {10}^{20}$$

Years are necessary. This demonstrates that the present sparse code, with even a very short duty cycle, produces astronomical combinations of codes. In addition a signal with such small duty cycle, i.e., 0.4% is not easily detectable with a super-heterodyne device such as a universal garage door opener.

According to a preferred embodiment, making legitimate copies of a GDO/RKE transmitter code and frequency is quite safe and not prone to hacking. The manufacturer supplies the code and frequency to the user. This information is entered into the universal remote for instance via only 3 or 4 keys.

### Training Procedure for Universal Transmitters and Add-on Receivers

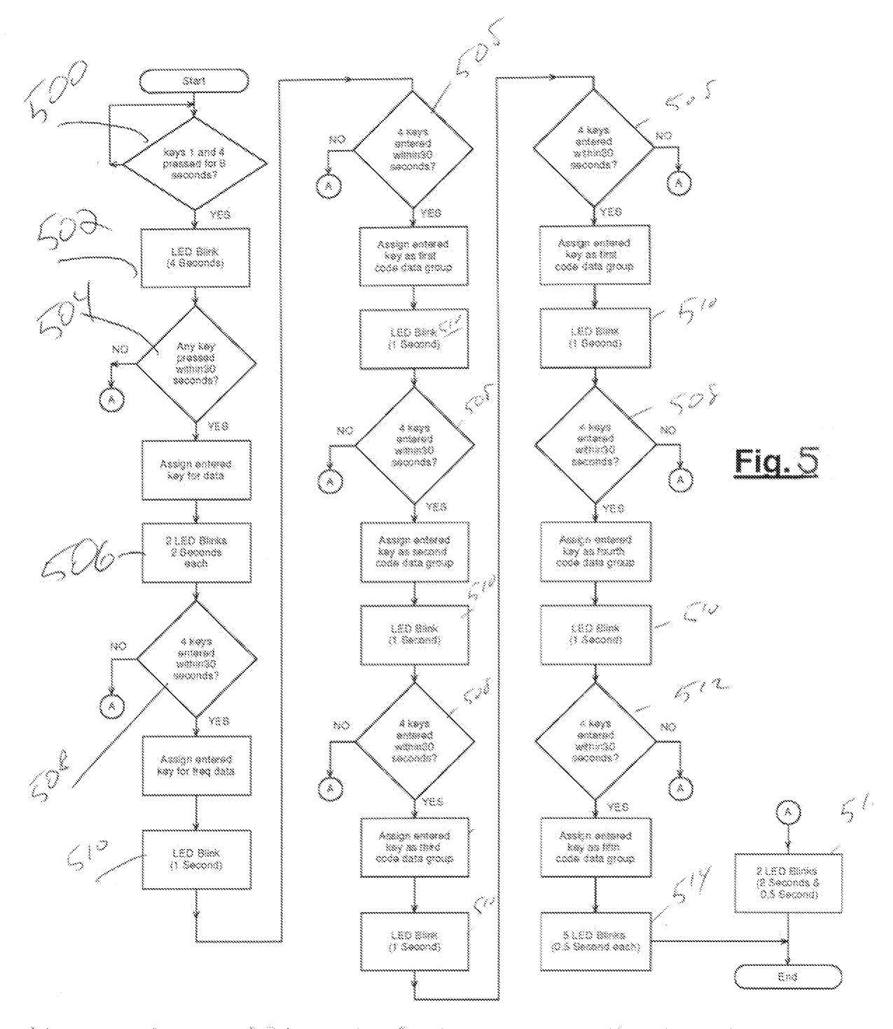

FIG. 5 depicts a flow chart for the training procedure described above. In one preferred embodiment, the codes do not reflect a one to one relationship of the location of the bits nor the frequency map, i.e., the digits are scrambled in order to provide a methodology more immune to being Investigated/analyzed by hackers.

The frequency and code information can be entered via the keys 106A-106B on transmitter 100. If there are 250 frequencies in the band of interest, the frequency can be entered via only 4 key entries as (250)₁₀=(3322)₄. If for example for a bit rate of 10 kbps, and a transmission time of 0.01 second, the total number of bit slots is K=1000. A selection of a sparse code with a length of 5-8 bits, i.e., L=5 and K=8 would require over 50,000 years to produce all the combinations. To assign bits sparsely with a sufficient separation which would not be identifiable by a super-heterodyne trainable transmitter, the bit slots (K=1000) can be divided into 8 sections of 125 bits wherein in each section there is maximum of one bit possibly present. The location of each bit within the pertinent section is described with four digits which are entered via the 4 keys present on the transmitter. To cover the entire K=1000 bit slots, 4×4=16 entries are necessary.

In a first scenario, at step 500-502 the user first alerts trainable transmitter (TT) 100 by pressing two keys simultaneously (e.g., 1 and 4 keys). After a certain period of time (e.g., 8 seconds) the responds by an LED blinks to inform the user that the training mode is initiated. Then, at step 504 the user presses the key which she/he intends to utilize after the subsequent training procedure. At step 506, LED 104 blinks multiple times (e.g., twice) to inform the user that the button which is selected to be programmed is recognized. The user is supplied with a 20 digit code (for both frequency and the sparse code). The digits of the 20 digit code are in the range of 1-4 (in contrast to the commonly used digits in base four, i.e., 0-3). To make the task for the user easier, the twenty digits are separated by dashes (e.g., 3224-1423-3323-1413-3411). At steps 508, as the user enters each group of four digits, the LED blinks once (steps 510). However, after the entry of the last group of digits at step 512, LED 104 blinks multiple times (e.g., 5 times at step 514) to indicate the completion of code entry. At any point during the training procedure, if the training is unsuccessful due to delays in entering the digits, at step 516 a long LED blink is followed by a short blink which alerts the user of unsuccessful training and the procedure is halted without any changes saved.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A system for remote entry, said system comprising:
at least one trainable radio frequency transmitter having a plurality of selectable codes, any of which selected in accordance with a corresponding training code data and
at least one receiver configured to receive signals from said radio frequency transmitter, wherein said radio frequency transmitter is configured to transmit, and said receiver is configured to receive, coded radio frequency transmissions containing at least sparse binary codes that include binary transmissions implemented with a small duty cycle, corresponding to said training code data.

2. The system as claimed in claim 1, wherein a transmission time of 0.1 S is used by said radio frequency transmitter.

3. The system as claimed in claim 2, wherein said small duty cycle is set to a range substantially between 0.2-0.4% of said transmission time.
